(19) United States
(12) Patent Application Publication
(10) Pub. No.: US 2013/0125023 A1
(43) Pub. Date: May 16, 2013

(54) SYSTEM AND METHOD OF SHARING APPLICATION INFORMATION

(71) Applicants: Jong-woo Jung, Hwaseong-si (KR); Ju-youn Lee, Seongnam-si (KR)

(72) Inventors: Jong-woo Jung, Hwaseong-si (KR); Ju-youn Lee, Seongnam-si (KR)

(73) Assignee: Samsung Electronics Co., Ltd., Suwon-si (KR)

(21) Appl. No.: 13/612,019

(22) Filed: Sep. 12, 2012

(30) Foreign Application Priority Data
Nov. 11, 2011 (KR) 10-2011-0117782

(51) Int. Cl. G06F 15/16; G06F 3/01

(52) U.S. Cl. 715/753

(57) ABSTRACT

Methods and apparatus are provided for sharing application information. Application information regarding a plurality of applications is stored. The application information is received from a plurality of user terminals. An application information request is received from a user terminal. The application information is edited. The edited application information is provided to the user terminal, in response to the application information request.

### PRIORITY

This application claims priority under 35 U.S.C. §119(a) to Korean Patent Application No. 10-2011-0117782, filed on Nov. 11, 2011, in the Korean Intellectual Property Office, the disclosure of which is incorporated herein by reference.

### BACKGROUND OF THE INVENTION

1. Field of the Invention

The present invention relates generally to a system and a method of sharing application information, and more particularly, to a system and a method of sharing information regarding a plurality of applications that are collected by a plurality of user terminals.

2. Description of the Related Art

Due to development of mobile communication technology, a mobile communication terminal is used, as a necessity, by almost everyone, and the demand therefor is expected to increase significantly. Accordingly, in order to distinguish their products from other companies' products, mobile communication companies have developed various contents and services for their own products, which are then provided to their customers.

In this regard, a one such service includes an online community service that arranges a space so as to allow users to directly produce and share information, and to act in the space. The community service allows a user to make a web-bulletin or a chat room according to a user's favorite subject via a community site. Users can then share information and opinions in particular groups. Thus, the community service is recognized as the most effective service to increase new service-users and to prevent withdrawal of existing service-users.

However, utilization of a community web space has decreased, and a community bulletin provided via an application installed in a user terminal is not frequently used due to a log-in procedure or inconvenience related to user inputs.

### SUMMARY OF THE INVENTION

The present invention has been made to address at least the above problems and/or disadvantages and to provide at least the advantages described below. Accordingly, an aspect of the present invention provides a system and a method of sharing application information so as to provide a user terminal with an effective community environment based on an application.

The present invention also provides a system and a method of sharing application information so as to effectively collect a plurality of pieces of application information from a plurality of user terminals, and then provide the plurality of pieces of application information to the user terminals.

The present invention additionally provides a system and a method of sharing application information so as to distinguish between a plurality of pieces of application information, which are collected from a plurality of user terminals, according to various references, and then provide the plurality of pieces of information to the user terminals.

According to an aspect of the present invention, a method is providing for sharing application information at a server. Application information regarding a plurality of applications is stored. The application information is received from a plurality of user terminals. An application information request is received from a user terminal. The application information is edited. The edited application information is provided to the user terminal, in response to the application information request.

According to another aspect of the present invention, a method is provided for sharing application information at a user terminal. A request for application information regarding an application is transmitted to a server. The application information is received from the server. The application information is displayed. The application information includes pieces of application information regarding a plurality of applications, which are collected by the server from a plurality of user terminals.

According to another aspect of the present invention, an application information providing server is provided that includes an application information DB for storing application information regarding a plurality of applications. The application information is received from a plurality of user terminals. The application information providing server also includes an application information request receiving unit for receiving an application information request from a user terminal. The application information providing server further includes an application information editing unit for editing the stored application information. The application information providing server also includes an application information providing unit for providing the edited application information to the at least one user terminal, in response to the application information request.

According to another aspect of the present invention, a user terminal is provided that shares application information with a plurality of user terminals. The user terminal includes an application information requesting unit for transmitting a request for application information to a server. The user terminal also includes an application information receiving unit for receiving the requested application information from the server, and a display unit for displaying the received application information. The application information includes pieces of application information regarding a plurality of applications. The pieces of application information are collected by the server from the plurality of user terminals.

According to another aspect of the present invention, an article of manufacture is provided for sharing application information, including a computer-readable recording medium having recorded thereon one or more programs, which when executed implement the steps of: storing application information regarding a plurality of applications, wherein the application information is received from a plurality of user terminals; receiving an application information request from a user terminal; editing the application information; and providing the edited application information to the user terminal, in response to the application information request.

According to another aspect of the present invention, an article of manufacture is provided for sharing application information, including a computer-readable recording medium having recorded thereon one or more programs, which when executed, implement the steps of: transmitting a request for application information regarding an application to a server; receiving the application information from the server; and displaying the application information, wherein the application information includes pieces of application information regarding a plurality of applications, and wherein the pieces of application information are collected by the server from a plurality of user terminals.

### BRIEF DESCRIPTION OF THE DRAWINGS

The above and other aspects, features and advantages of the present invention will become more apparent from the following detailed description when taken in conjunction with the accompanying drawings, in which:

FIG. 1 is a diagram illustrating an overall configuration of an application information sharing system, according to an embodiment of the present invention;

FIG. 2 is a diagram illustrating a detailed structure of an application information providing server, according to an embodiment of the present invention;

FIG. 3 is a diagram illustrating a detailed structure of a user terminal, according to an embodiment of the present invention;

FIG. 4 illustrates an application information table stored in an application information DataBase (DB), according to an embodiment of the present invention;

FIGS. 5 and 6 illustrate screens in which application information is requested while an application is being executed, according to an embodiment of the present invention;

FIG. 7 illustrates a screen in which a plurality of pieces of application information are time-sequentially displayed on the user terminal, according to an embodiment of the present invention;

FIG. 8 illustrates a screen in which application information is displayed on the user terminal based on a location, according to an embodiment of the present invention;

FIG. 9 illustrates a screen in which a plurality of pieces of application information, according to applications, are displayed on the user terminal, according to an embodiment of the present invention;

FIG. 10 illustrates a screen in which a plurality of pieces of application information, according to users, are displayed on the user terminal, according to an embodiment of the present invention;

FIGS. 11 and 12 illustrate screens in which application information regarding a specific user is displayed on the user terminal, according to an embodiment of the present invention;

FIG. 13 is a flowchart illustrating a method of providing, by an application information providing server, sharing of application information, according to an embodiment of the present invention;

FIG. 14 is a flowchart illustrating a method of sharing, by a user terminal, application information, according to an embodiment of the present invention;

FIG. 15 is a flowchart illustrating a method of sharing application information in an application information sharing system, according to an embodiment of the present invention; and

FIG. 16 is a diagram illustrating an overall configuration of an application information sharing system, according to an embodiment of the present invention.

### DETAILED DESCRIPTION OF EMBODIMENTS OF THE PRESENT INVENTION

Embodiments of the present invention are described in detail with reference to the accompanying drawings. The same or similar components may be designated by the same or similar reference numerals although they are illustrated in different drawings. Detailed descriptions of constructions or processes known in the art may be omitted to avoid obscuring the subject matter of the present invention.

Throughout the specification, it will also be understood that when an element is referred to as being “connected to” another element, it can be directly connected to the other element, or electrically connected to the other element while intervening elements may also be present. Also, when a part “includes” or “comprises” an element, unless there is a particular description contrary thereto, the part can further include other elements, not excluding the other elements.

Expressions such as “at least one of,” when preceding a list of elements, modify the entire list of elements and do not modify the individual elements of the list.

In an application information sharing system, according to an embodiment of the present invention, a plurality of pieces of application information that are provided by a plurality of user terminals are collected and classified, so that the user terminals may share the plurality of pieces of application information.

Also, application information, according to an embodiment of the present invention, is related to an application provided by a user terminal and is shared between a plurality of user terminals. For example, the application information includes comment information regarding the application, comment information regarding content provided from the application, an IDentification (ID) value of the application, an ID value of a user terminal that uses the application, an ID value of a user of the user terminal, location information of the user terminal, content or link information regarding the content provided from the application, time information regarding the comment information, and the like.

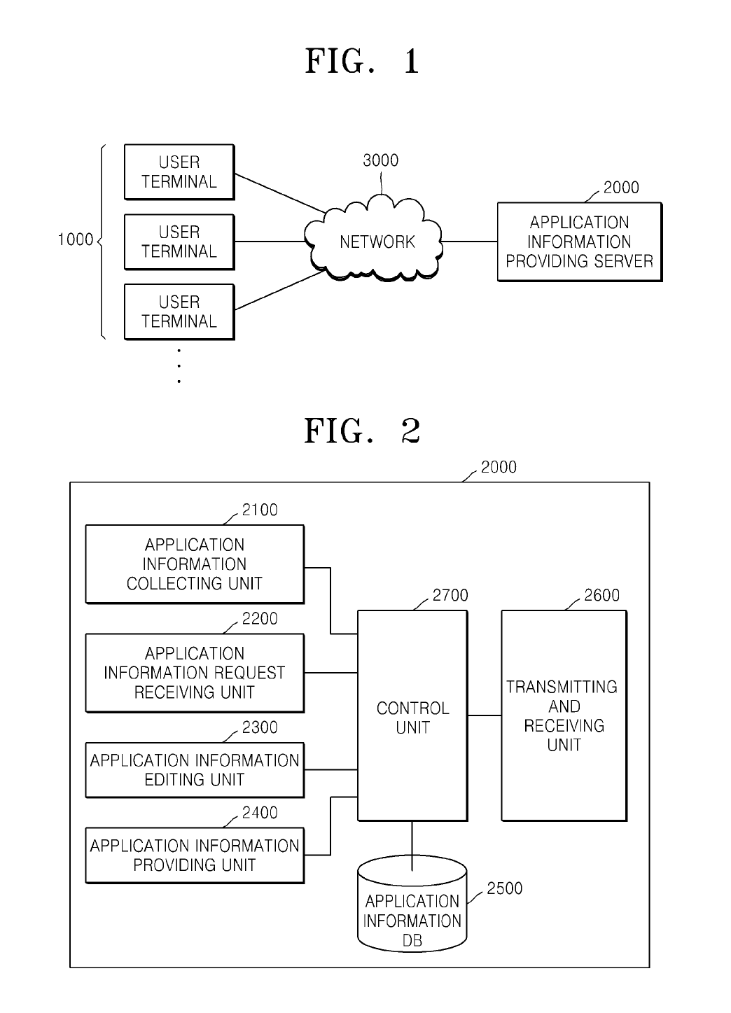

FIG. 1 is a diagram illustrating an overall configuration of an application information sharing system, according to an embodiment of the present invention.

As illustrated in FIG. 1, the application information sharing system includes a plurality of user terminals 1000, an application information providing server 2000, and a network 3000.

The plurality of user terminals 1000 generate and provide pieces of application information to the application information providing server 2000. The application information providing server 2000 collects the pieces of application information received from the plurality of user terminals 1000, and stores the plurality of pieces of application information. A user terminal 1000 may provide the application information providing server 2000 with various pieces of information regarding a user comment for at least one application installed in the user terminal 1000, and a usage history of the application. The user terminal 1000 includes all types of devices that may be connected to the application information providing server 2000 via a wired or wireless network.

The application information providing server 2000 may edit the plurality of pieces of application information collected from the plurality of user terminals 1000, according to various references, and may provide the edited application information to the user terminals 1000.

The network 3000 includes, for example, a dedicated line, a Local Area Network (LAN), a Value-Added Network (VAN), an intranet, a private phone network, a public phone network, a Public Switched Telephone Network (PSTN), or a combination thereof. The network 3000 is a general data communication network that allows configuring bodies of FIG. 1 to smoothly communicate with each other, and includes, for example, a wired internet, a wireless internet, or a mobile wireless communication network.

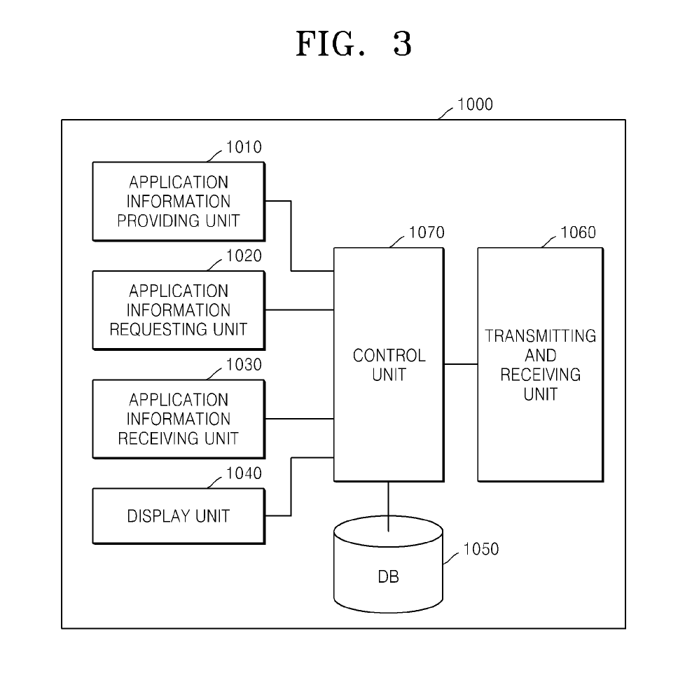

FIG. 2 is a diagram illustrating a detailed structure of the application information providing server 2000, according to an embodiment of the present invention.

As illustrated in FIG. 2, the application information providing server 2000 includes an application information collecting unit 2100, an application information request receiving unit 2200, an application information editing unit 2300, an application information providing unit 2400, an application information DB 2500, a transmitting and receiving unit 2600, and a control unit 2700.

The application information collecting unit 2100 collects pieces of application information from user terminals 1000. The application information collecting unit 2100 may receive the pieces of application information regarding one or more applications installed in the user terminals 1000 from each of the user terminals 1000, respectively. For example, the application information may include at least one of an ID value of an application, an ID value of the user terminal 1000 that uses the application, an ID value of a user using the user terminal 1000, location information of the user terminal 1000, comment information regarding the application, information regarding content included in the application, comment information regarding the content, and time information regarding a time at which the comment information regarding the application or the comment regarding the content is provided. Also, the content included in the application may be a moving picture or a still image, and the information regarding the content may include at least one of a content file and link information regarding the content.

The application information request receiving unit 2200 receives an application information request from the user terminal 1000. The user terminal 1000 may request the application information request receiving unit 2200 for application information that is related to a predetermined application and has been collected from another user terminal. The application information request receiving unit 2200 may receive the application information request from the user terminal 1000. The application information request receiving unit 2200 may also receive a request for application information that is edited based on time, location, an application, or a terminal.

The application information editing unit 2300 edits the application information. The application information editing unit 2300 may edit the application information stored in the application information DB 2500, in response to the application information request.

The application information editing unit 2300 may also edit the application information based on an address book corresponding to the user terminal 1000. For example, the application information editing unit 2300 may extract application information from the application information DB 2500, based on a telephone number of another user terminal included in the address book stored in the user terminal 1000, and may edit the application information collected from the other user terminal. The address book corresponding to the user terminal 1000 may be stored in the user terminal 1000, but embodiments of the present invention are not limited thereto, and the address book may be stored in a separate storage space that is apart from the user terminal 1000.

The application information editing unit 2300 may also edit application information that is to be provided to the user terminal 1000, based on a time of collecting the application information. For example, the application information editing unit 2300 may time-sequentially arrange a plurality of pieces of application information that are related to a plurality of applications and that are uploaded by other user terminals.

The application information editing unit 2300 may edit application information to be provided to the user terminal 1000, based on a location at which the application information was collected. The application information editing unit 2300 may extract the application information that is uploaded by another user terminal within a pre-defined range from a current location of the user terminal 1000, based on location information of the user terminal 1000, and may edit the application information.

The application information editing unit 2300 may edit pieces of application information according to applications. Based on ID values of the applications, the application information editing unit 2300 may arrange and edit the pieces of application information received from other terminals, according to the applications. In this case, the application information editing unit 2300 may add information to the application information. The information indicates whether the applications are installed in the user terminal 1000. Also, the application information editing unit 2300 may generate information regarding the number of users using the applications and the number of comments regarding the applications, according to the applications.

The application information editing unit 2300 may also edit application information according to content. Specifically, the application information editing unit 2300 may extract and edit application information regarding specific content, based on an ID value of the content. For example, the application information editing unit 2300 may identify content according to a file name of the content or metadata applied to the content. Also, the application information editing unit 2300 may extract and edit information regarding a comment related to specific content, which is uploaded by another terminal, and regarding a name of an application that executes the specific content.

The application information editing unit 2300 may edit pieces of application information, according to user terminals. Based on ID values of the user terminals, the application information editing unit 2300 may classify the pieces of application information according to the user terminals, and may edit the pieces of application information. Also, the application information editing unit 2300 may generate information regarding the number of used applications and the number of uploaded comments, according to the user terminals.

The application information editing unit 2300 may also edit pieces of application information, according to users. Based on ID values of the users using the user terminals, the application information editing unit 2300 may classify and edit pieces of uploaded application information, according to the users. Also, the application information editing unit 2300 may generate information regarding the number of used applications and the number of uploaded comments, according to the users.

The application information providing unit 2400 provides the application information to the user terminal 1000. The application information providing unit 2400 may generate a User Interface (UI) by using edited application information and may provide the generated UI to the user terminal 1000. Also, the application information providing unit 2400 may provide the edited application information to the user terminal 1000 and may allow the user terminal 1000 to generate a UI by using the edited application information, but is not limited thereto.

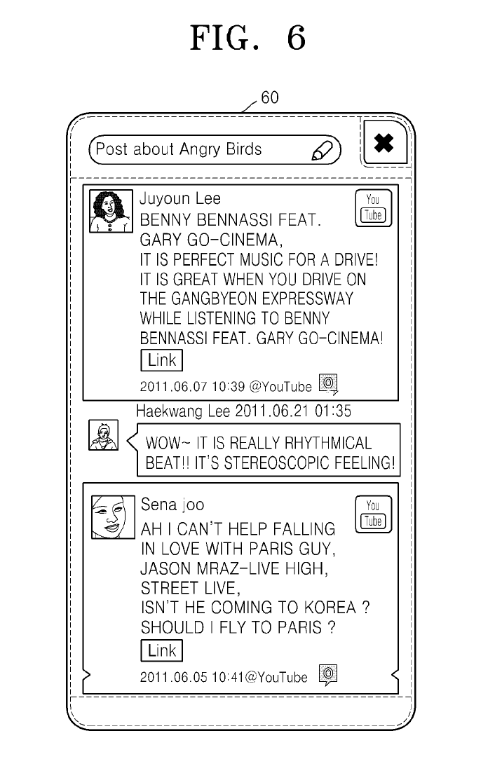

The application information DB 2500 stores the application information. For example, the application information DB 2500 may store an ID value of an application, an ID value of the user terminal 1000 that uses the application, an ID value of a user using the user terminal 1000, location information of the user terminal 1000, comment information regarding the application, information regarding content included in the application, comment information regarding the content, and time information regarding a time at which the comment information is provided. Examples of the application information collected by the application information collecting unit 2100 from the plurality of user terminals 1000 is described in detail below with reference to FIG. 5.

The transmitting and receiving unit 2600 exchanges various types of information with the plurality of user terminals 1000, so as to allow the plurality of user terminals 1000 to share application information.

The control unit 2700 controls an overall operation of the application information providing server 2000. In order to allow the application information providing server 2000 to collect a plurality of pieces of application information from the plurality of user terminals 1000, to edit the plurality of pieces of application information, and to provide the plurality of pieces of application information to the user terminal 1000, the control unit 2700 controls the application information collecting unit 2100, the application information request receiving unit 2200, the application information editing unit 2300, the application information providing unit 2400, the application information DB 2500, and the transmitting and receiving unit 2600.

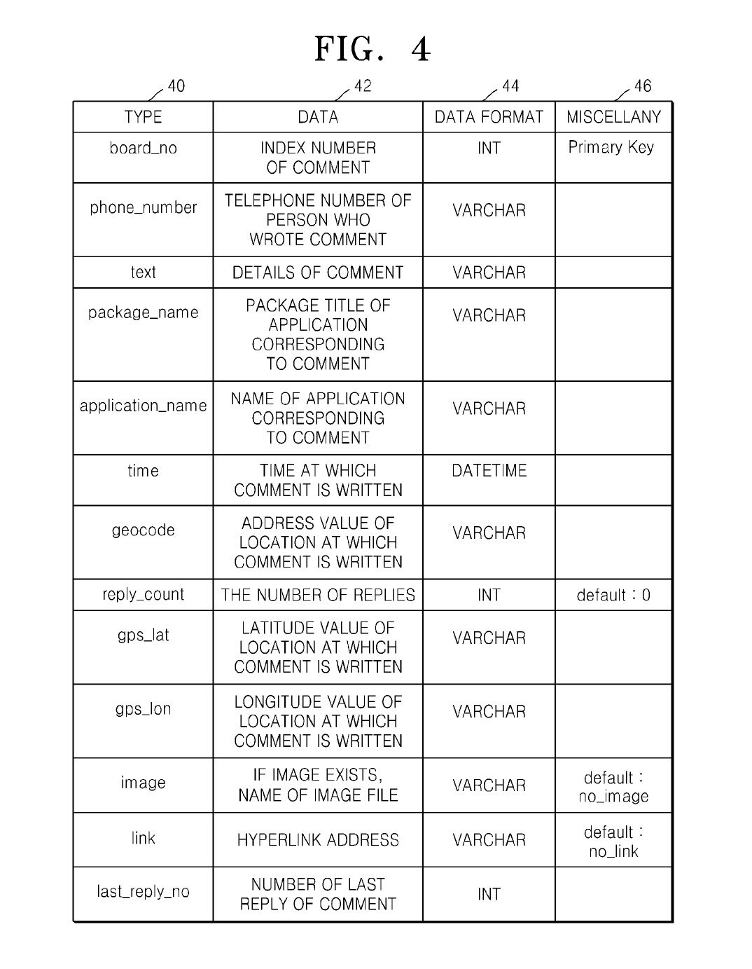

FIG. 3 is a diagram illustrating a detailed structure of a user terminal 1000, according to an embodiment of the present invention.

As illustrated in FIG. 3, the user terminal 1000 includes an application information providing unit 1010, an application information requesting unit 1020, an application information receiving unit 1030, a display unit 1040, a DB 1050, a transmitting and receiving unit 1060, and a control unit 1070.

The application information providing unit 1010 provides application information to the application information providing server 2000. The application information providing unit 1010 may provide the application information to the application information providing server 2000, based on user input. The application information providing unit 1010 may provide the application information providing server 2000 with a comment input by a user. The comment is related to an application executed in the user terminal 1000, and link information regarding specific content in the application. For example, the application information providing unit 1010 may provide the application information providing server 2000 with an ID value of the user terminal 1000, an ID value of a user using the user terminal 1000, and location information of the user terminal 1000.

The application information requesting unit 1020 requests application information from the application information providing server 2000. The application information requesting unit 1020 may check an application executed in the user terminal 1000 and may request application information regarding the executed application. Also, the application information requesting unit 1020 may request application information that is edited according to a pre-defined reference based on user input. While the application is executed in the user terminal 1000, the user may touch and drag a panel in a downward direction to a lower portion of the screen. The panel is originally positioned on an upper portion of a screen. The user may click a pre-set field displayed on the panel that was dragged down to the lower portion of the screen. By doing so, the user may allow the application information requesting unit 1020 to request the application information.

Based on the address book stored in the user terminal 1000, the application information requesting unit 1020 may request the application information providing server 2000 for application information uploaded by another user terminal corresponding to a telephone number stored in the address book.

Also, the application information requesting unit 1020 may request the application information providing server 2000 to provide pieces of application information collected from other user terminals, in an order based on a time of upload.

The application information requesting unit 1020 may also provide a location value of the user terminal 1000 to the application information providing server 2000, and may request the application information providing server 2000 to provide application information that is uploaded by another user terminal within a pre-defined range from the location value of the user terminal 1000.

The application information requesting unit 1020 may provide ID values of applications to the application information providing server 2000, and may request the application information providing server 2000 to provide pieces of application information collected from other user terminals, according to the applications.

Also, the application information requesting unit 1020 may request the application information providing server 2000 to provide application information according to content. Specifically, the application information providing server 2000 may identify content based on a file name of the content or metadata applied to the content, and may provide uploaded application information regarding the identified content.

The application information requesting unit 1020 may also request the application information providing server 2000 to provide application information according to each user terminal or each user.

The application information receiving unit 1030 receives application information from the application information providing server 2000. The application information receiving unit 1030 may receive edited application information from the application information providing server 2000, based on an application information request. Alternatively, the application information receiving unit 1030 may receive a UI (e.g., an application information sharing window), which is generated based on the edited application information, from the application information providing server 2000, however, embodiments of the present invention are not limited thereto.

The display unit 1040 displays received application information on a screen of the user terminal 1000. The display unit 1040 may generate the UI (e.g., the application information sharing window) by using the edited application information received from the application information providing server 2000, and may display the generated UI. When the UI (e.g., the application information sharing window) is received from the application information providing server 2000, the display unit 1040 may display the received UI on the screen.

The DB 1050 stores various types of information required to share application information with other user terminals.

The transmitting and receiving unit 1060 exchanges the various types of information, which is required to share the application information, with the application information providing server 2000 and other user terminals.

The control unit 1070 controls an overall operation of the user terminal 1000. In order to allow the user terminal 1000 to provide the application information to the application information providing server 2000, to receive application information, which is uploaded by another user terminal, from the application information providing server 2000, and to share the application information with the other user terminal, the control unit 1070 controls the application information providing unit 1010, the application information requesting unit 1020, the application information receiving unit 1030, the display unit 1040, the DB 1050, and the transmitting and receiving unit 1060.

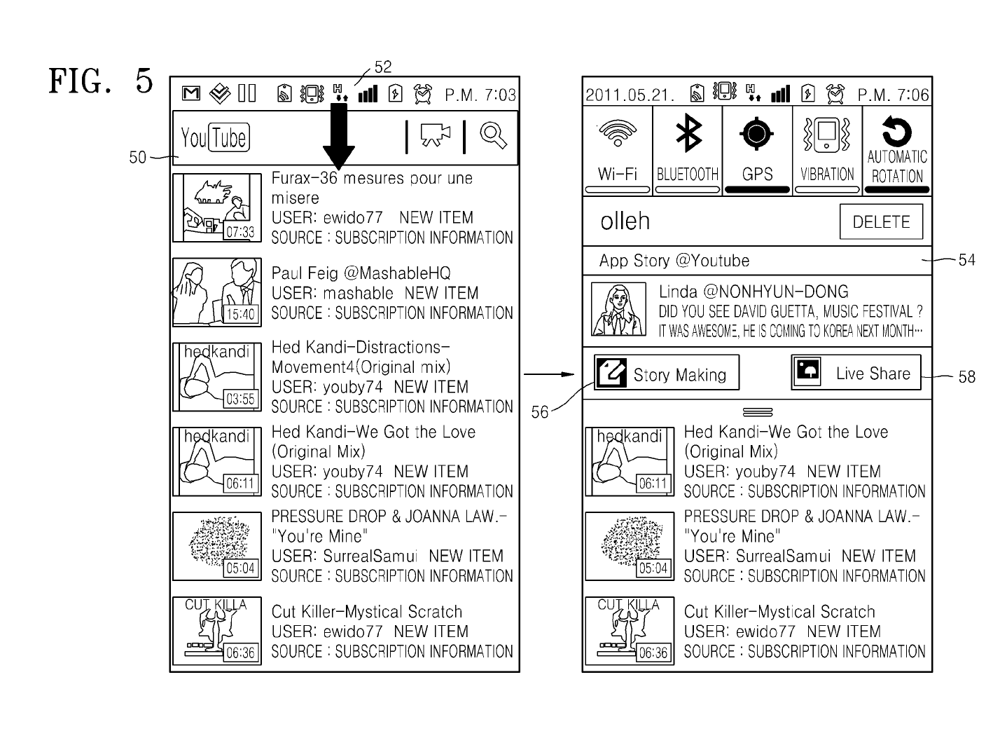

FIG. 4 shows an application information table stored in the application information DB 2500, according to an embodiment of the present invention.

As illustrated in FIG. 4, the application information table includes a type field 40, a data field 42, a data format field 44, and a miscellany field 46.

ID values regarding types of application information are recorded in the type field 40. For example, board_no, phone_number, text, package_name, application_name, time, geocode, reply_count, gps_lat, gps_lon, and image link_last reply_no may be recorded in the type field 40.

Data corresponding to an ID value of the application information is recorded in the data field 42. For example, an index number of a comment, a telephone number of a person who wrote the comment, details of the comment, a package title of an application corresponding to the comment, a name of the application corresponding to the comment, a time at which the comment is written, an address value of a location at which the comment is written, the number of replies, a latitude value of the location at which the comment is written, a longitude value of the location at which the comment is written, a name of an image file (if an image file exists), a hyperlink address, and a number of a last reply of the comment, may be recorded in the data field 42.

A data format, such as, INT, VARCHER, DATETIME, or the like, is recorded in the data format field 44. Additional information related to data is recorded in the miscellany field 46.

Thus, the application information providing server 2000 may collect pieces of application information from a plurality of user terminals, may effectively manage the pieces of application information, may classify and edit the pieces of application information according to various references, and may provide the pieces of application information to the user terminal 1000.

FIGS. 5 and 6 illustrate screens in which application information is requested while an application is being executed, according to an embodiment of the present invention.

As illustrated in FIG. 5, while a “You Tube”® application is being executed in the user terminal 1000, a user may touch and drag a panel 52, which is positioned on an upper portion of a screen of the user terminal 1000, in a downward direction, so that a quick panel 54 for sharing application information may be displayed. The user may also touch specific content displayed on a “You Tube”®-application execution screen 50, in order to display the quick panel 54. The quick panel 54 may include an information input field 56 and a content sharing field 58.

When the user touches the information input field 56, an application information sharing window 60 may be displayed, as illustrated in FIG. 6. The user may check other users' comments and may input a comment regarding the application, or a comment regarding the specific content displayed in the application, via the application information sharing window 60. When the user inputs the comment, the input comment and also an ID value of the application, an ID value of a user terminal that uses the application, an ID value of the user using the user terminal, location information of the user terminal, content or link information regarding the content provided from the application, and time information regarding a time at which the comment information is provided, may also be provided to the application information providing server 2000.

When the user touches the content sharing field 58, the content or the link information regarding the content provided from the application may be uploaded to the application information sharing window 60. In this case, the user may touch a link for the content and may receive a content file from the application information providing server 2000.

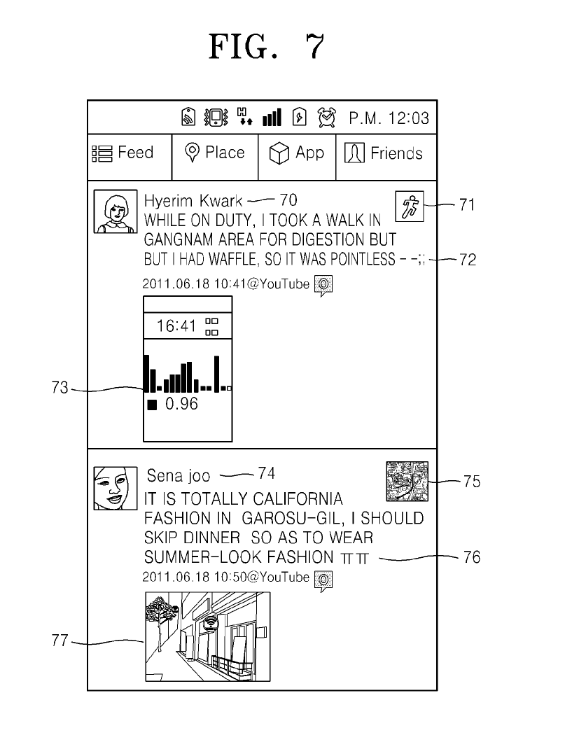

FIG. 7 illustrates a screen in which a plurality of pieces of application information are time-sequentially displayed on the user terminal 1000, according to an embodiment of the present invention.

As illustrated in FIG. 7, the plurality of pieces of application information uploaded by the plurality of user terminals 1000 may be time-sequentially arranged and displayed on an application information sharing window. In more detail, user ID values 70 and 74, icons 71 and 75 of applications used by users, and user comments 72 and 76 may be displayed. Also, contents 73 and 77 used by the users via the applications may also be displayed.

Thus, a user may effectively check information regarding various applications and contents used by other users via the application information sharing window, may obtain an application and content appropriate for the user, and may effectively communicate with his or her friends.

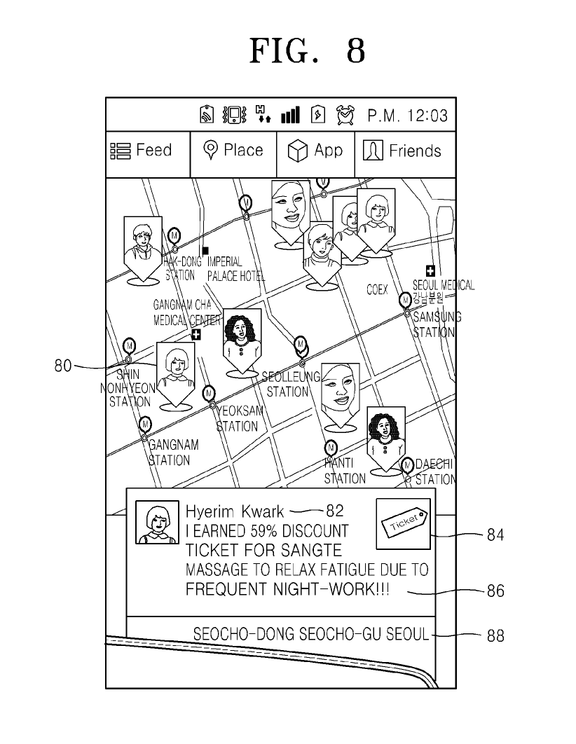

FIG. 8 illustrates a screen in which application information is displayed on the user terminal 1000 based on a location, according to an embodiment of the present invention.

As illustrated in FIG. 8, a plurality of pieces of application information that are uploaded within a pre-defined range from the location of the user terminal 1000 may be displayed on a map in an application information sharing window. Also, a user image 80 of another user who has uploaded the application information may be displayed at a position where the application information is uploaded. When the user image 80 is selected, a user ID value 82, an icon 84 of an application used by the other user, a user comment 86, and an address value 88 of a place in which the user comment 86 is uploaded may be displayed on the application information sharing window.

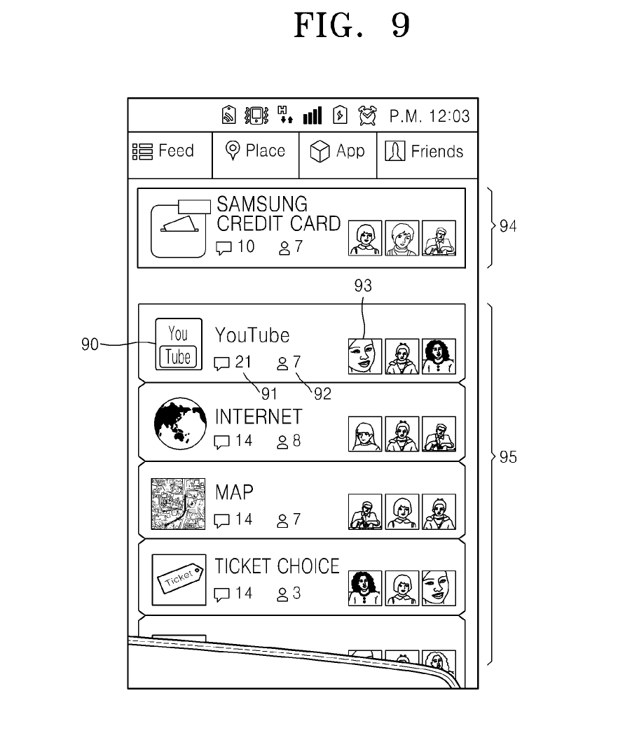

FIG. 9 illustrates a screen in which pieces of application information are displayed on the user terminal 1000 based on applications, according to an embodiment of the present invention.

As illustrated in FIG. 9, the pieces of application information, according to applications, may be arranged and displayed on an application information sharing window. In more detail, an application icon 90 for each application, the number of comments 91 for each application, the number of users 92 using each application, and user images 93 may be displayed on the application information sharing window. Also, a plurality of pieces of information regarding other users (91, 92, and 93 of FIG. 9) may be displayed on the application information sharing window of FIG. 9, based on an address book stored in the user terminal 1000. The user images 93 may be arrayed in an order corresponding to the number of uploaded comments with respect to a corresponding application.

Also, application information 94 regarding an application installed in the user terminal 1000, and application information 95 regarding applications not installed in the user terminal 1000 may be separately displayed on the application information sharing window.

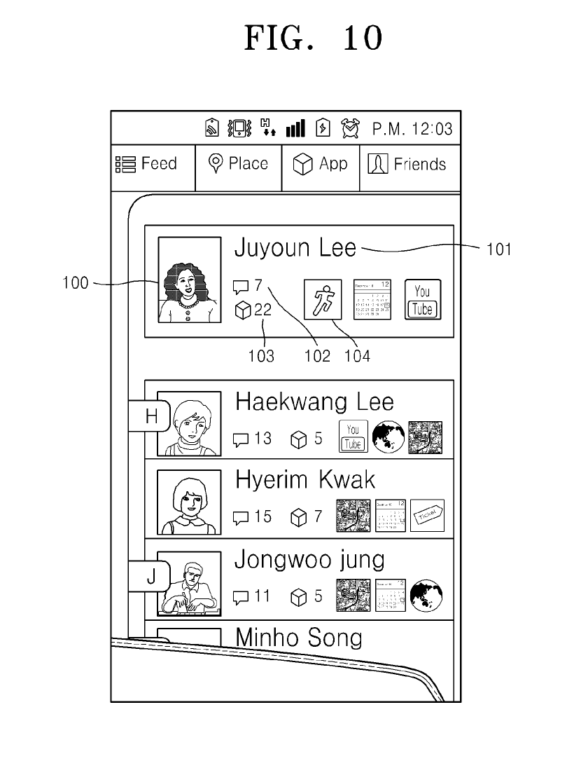

FIG. 10 illustrates a screen in which a plurality of pieces of application information are displayed on the user terminal 1000 based on users, according to an embodiment of the present invention.

As illustrated in FIG. 10, the pieces of application information may be arranged and displayed on the application information sharing window based on users. In more detail, user images 100, a user ID value 101, a number of comments 102, a number of pieces of contents 103, and application icons 104 may be displayed on the application information sharing window. Also, pieces of information may be displayed on the application information sharing window of FIG. 9, based on users and an address book stored in the user terminal 1000. The application icons 104 used by a user may be arranged according to at least one of a frequency of use, the number of uploaded comments, and the number of uploaded contents. The user images 100 may be arranged according to at least one of the number of uploaded comments, the number of uploaded contents, and a frequency of phone calling with the user terminal 1000.

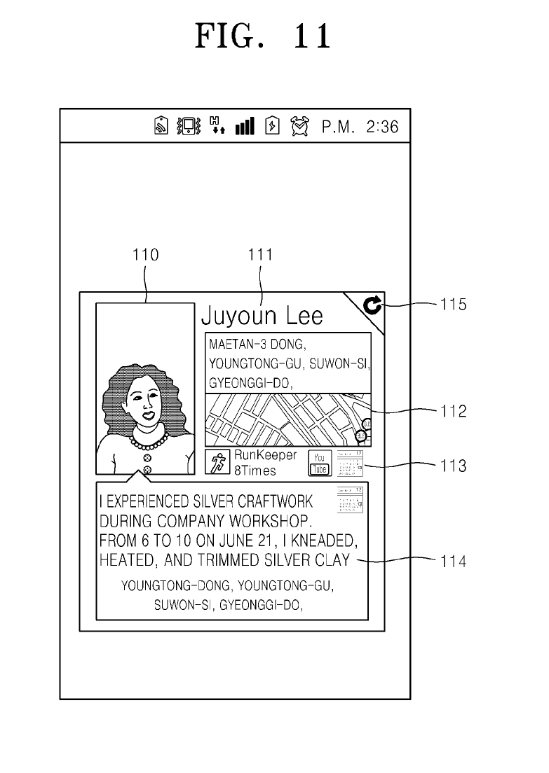

FIGS. 11 and 12 illustrate screens in which application information regarding a specific user is displayed on the user terminal 1000, according to an embodiment of the present invention.

As illustrated in FIG. 11, the application information regarding a specific user may be displayed in the form of a card on an application information sharing window. In more detail, a user image 110, a user ID value 111, a user address 112, an application image 113 for an application used by a user, and a comment 114 regarding a specific application may be displayed on the application information sharing window.

Also, when the user touches a particular region 115 of the application information sharing window, a rear surface 120 of the application information sharing window in the form of a card may be displayed, as illustrated in FIG. 12, and detail information regarding the application may be displayed on the rear surface 120.

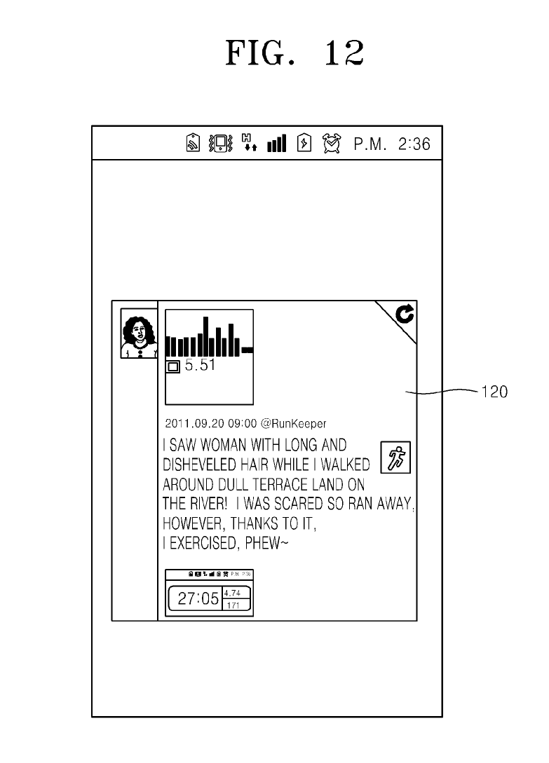

FIG. 13 is a flowchart illustrating a method of sharing, by an application information providing server, application information, according to an embodiment of the present invention.

In step S1300, pieces of application information are collected from user terminals. More specifically, in step S1300, the application information providing server may receive pieces of application information regarding one or more applications installed in the user terminals from each of the user terminals, respectively. For example, the application information may include at least one of an ID value of an application, an ID value of the user terminal that uses the application, an ID value of a user using the user terminal, location information of the user terminal, comment information regarding the application, information regarding content included in the application, comment information regarding the content, and time information regarding a time at which the comment information regarding the application or the comment is provided. Also, the content included in the application may be a moving picture or a still image, and the information regarding the content may include at least one of a content file and link information regarding the content.

In step S1302, an application information request is received from the user terminal. The user terminal may request application information that is related to a predetermined application and is collected from another user terminal, from the application information providing server. The application information providing server may also receive a request for application information from the user terminal, in which the application information is edited based on time, location, an application, or a terminal.

In step S1304, the pieces of collected application information are edited. Specifically, the application information providing server may edit the application information stored in an application information DB, in response to the application information request.

Also, in step S1304, the application information providing server may edit the application information based on an address book corresponding to the user terminal. For example, the application information providing server may extract application information from the application information DB, based on a telephone number of another user terminal included in the address book stored in the user terminal, and may edit the application information collected from the other user terminal. In this embodiment of the present invention, the address book corresponding to the user terminal may be stored in the user terminal or a separate storage space apart from the user terminal.

In step S1304, the application information providing server may edit the application information that is to be provided to the user terminal, based on a time of collecting the application information. Specifically, the application information providing server may arrange pieces of application information that are related to a plurality of applications and that are uploaded by other user terminals in a time sequential manner.

In step S1304, the application information providing server may also edit application information to be provided to the user terminal, based on a location at which the application information was collected. The application information providing server may extract the application information that is uploaded by another user terminal within a pre-defined range from a current location of the user terminal, based on location information of the user terminal, and may edit the application information.

Also, in step S1304, the application information providing server may edit pieces of application information according to applications. Based on ID values of the applications, the application information providing server may arrange and edit the pieces of application information received from other terminals, according to the applications. In this embodiment of the present invention, the application information providing server may add information to the application information, which indicates whether the applications are installed in the user terminal. Further, in step S1304, the application information providing server may generate information regarding the number of users using the applications and the number of comments regarding the applications, according to the applications.

In step S1304, the application information providing server may edit application information according to content. Specifically, the application information providing server may extract and edit application information regarding specific content, based on an ID value of the content. For example, the application information providing server may identify the content according to a file name of the content or metadata applied to the content. Also, the application information providing server may extract and edit information regarding a comment related to the specific content, which is uploaded by another terminal, and regarding a name of an application that executes the specific content.

Also, in step S1304, the application information providing server may edit pieces of application information, according to the user terminals. Based on ID values of the user terminals, the application information providing server may classify the pieces of application information according to the user terminals and may edit the pieces of application information. Also, in step S1304, the application information providing server may generate information regarding the number of used applications and the number of uploaded comments, according to the user terminals.

In step S1304, the application information providing server may edit pieces of application information, according to users. Based on ID values of the users using the user terminals, the application information providing server may classify and edit a plurality of pieces of uploaded application information, according to the users. Also, in step S1304, the application information providing server may generate information regarding the number of used applications and the number of uploaded comments, according to the users.

In step S1306, the application information providing server provides the application information to the user terminal. In step S1306, the application information providing server may generate a UI by using edited application information and may provide the generated UI to the user terminal. Also, the application information providing server may provide the edited application information to the user terminal and may allow the user terminal to generate a UI by using the edited application information, however, embodiments of the present invention are not limited thereto.

Also, in step S1306, when a user touches a field for sharing specific content on an application information sharing window displayed on the user terminal, the application information providing server may provide the specific content or link information used to receive the specific content. The user terminal may also download corresponding content based on the received link information.

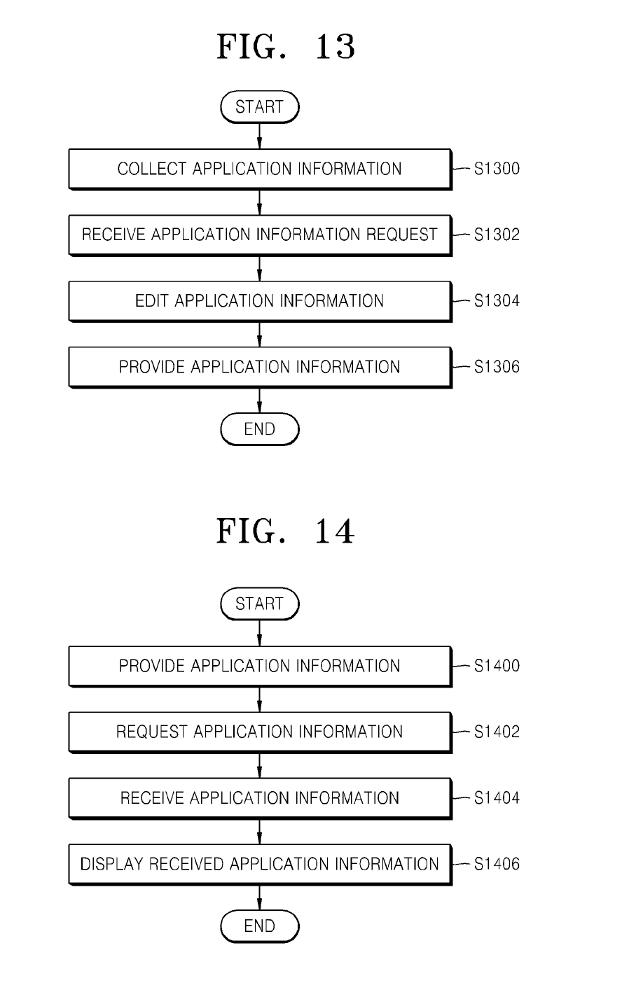

FIG. 14 is a flowchart illustrating a method of sharing, by a user terminal, application information, according to an embodiment of the present invention.

In step S1400, the application information is provided. Specifically, in step S1400, the user terminal may provide the application information to an application information providing server, based on a user input. The user terminal may provide the application information providing server with a comment input by a user. The comment is related to an application executed in the user terminal, and link information regarding specific content in the application. For example, the user terminal may provide the application information providing server with an ID value of the user terminal, an ID value of a user using the user terminal, and location information of the user terminal.

In step S1402, application information is requested. Specifically, in step S1402, the user terminal may check an application executed in the user terminal and may request application information regarding the executed application. Also, in step S1402, the user terminal may request application information that is edited according to a pre-defined reference, based on user input. While the application is being executed in the user terminal, a user may touch and drag a panel, which is positioned on an upper portion of a screen, in a downward direction to a lower portion of the screen, and may click a pre-set field displayed on the panel that is dragged down to the lower portion. In accordance with this action, the user may allow the user terminal to request the application information.

Also, in step S1402, based on an address book stored in the user terminal, the user terminal may request application information uploaded by another user terminal, corresponding to a telephone number stored in the address book, from the application information providing server.

In step S1402, the user terminal may request pieces of application information collected from other user terminals, according to an order of uploading times, from the application information providing server.

In step S1402, the user terminal may also provide a location value of the user terminal to the application information providing server, and may request the application information providing server to provide application information that is uploaded by another user terminal within a pre-defined range from the location value of the user terminal.

Also, in step S1402, the user terminal may provide ID values of applications to the application information providing server, and may request the application information providing server to provide a plurality of pieces of application information collected from other user terminals, according to the applications.

In step S1402, the user terminal may request application information according to each content from the application information providing server. The application information providing server may identify the content based on a file name of the content or metadata applied to the content, and may provide uploaded application information regarding the identified content.

In step S1402, the user terminal may also request application information from the application information providing server, according to each user terminal or each user.

In step S1404, the application information is received. In step S1404, the user terminal may receive edited application information from the application information providing server, based on an application information request. Alternatively, the user terminal may receive a UI (e.g., an application information sharing window), which is generated based on the edited application information, from the application information providing server, however, embodiments of the present invention are not limited thereto.

In step S1406, the received application information is displayed on a screen of the user terminal. Specifically, in step S1406, the user terminal may generate the UI (e.g., the application information sharing window) by using the edited application information received from the application information providing server, and may display the generated UI. Also, when the UI (e.g., the application information sharing window) is received from the application information providing server, the user terminal may display the received UI on the screen.

Also, the user terminal may provide the application information to the application information providing server via the application information sharing window, and may receive application information, which is uploaded by another user, from the application information providing server.

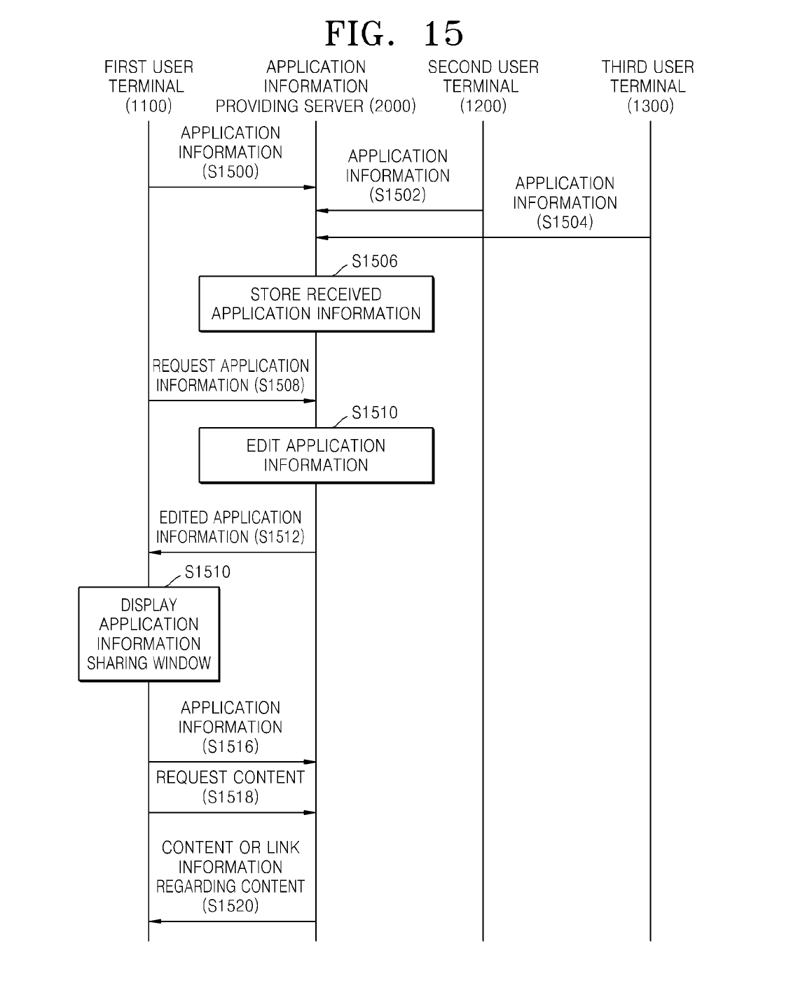

FIG. 15 is a flowchart illustrating a method of sharing application information in an application information sharing system, according to an embodiment of the present invention.

In steps S1500 through S1504, the application information providing server 2000 collects pieces of application information from a first user terminal 1100, a second user terminal 1200, and a third user terminal 1300. For example, the application information includes comment information regarding an application, comment information regarding content provided from the application, an ID value of the application, an ID value of a user terminal that uses the application, an ID value of a user of the user terminal, location information of the user terminal, content or link information regarding the content provided from the application, time information regarding the comment information, and the like.

In step S1506, the pieces of application information collected by the application information providing server 2000 are stored. The application information providing server 2000 may store the pieces of application information regarding a plurality of applications.

In step S1508, the application information providing server 2000 receives an application information request from the first user terminal 1100. In step S1508, the application information providing server 2000 may receive a request to provide application information that is edited according to a time, a location, an application, or a terminal, from the first user terminal 1100.

In step S1510, the application information providing server 2000 edits application information, and in step S1512, the application information providing server 2000 provides the edited application information to the first user terminal 1100.

In step S1514, the first user terminal 1100 displays an application information sharing window. The first user terminal 1100 may receive the application information sharing window including the application information from the application information providing server 2000, but is not limited thereto. The first user terminal 1100 may generate the application information sharing window by using received application information.

In step S1516, the first user terminal 1100 provides application information to the application information providing server 2000. In step S1516, the first user terminal 1100 may provide the application information to the application information providing server 2000 via the application information sharing window.

In step S1518, the first user terminal 1100 requests content from the application information providing server 2000. In step S1520, the first user terminal 1100 receives the content or link information corresponding to the content from the application information providing server 2000. Also, the first user terminal 1100 may download the content from an external source, based on the link information corresponding to the content.

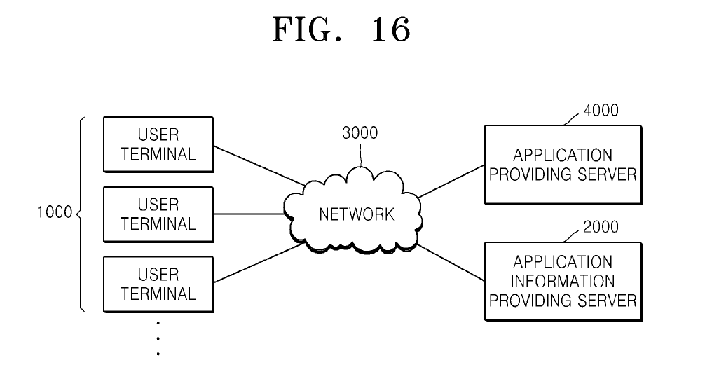

FIG. 16 is a diagram illustrating an overall configuration of an application information sharing system, according to an embodiment of the present invention.

As illustrated in FIG. 16, the application information sharing system includes user terminals 1000, the application information providing server 2000, a network 3000, and an application providing server 4000. The application information providing server 2000 may receive application information from the user terminal 1000 and the application providing server 4000, and may provide application information to the user terminal 1000.

The application providing server 4000 provides an application to the user terminal 1000. Also, the application providing server 4000 provides the user terminal 1000 with link information regarding content displayed in the application, so as to allow the user terminal 1000 to provide the link information regarding content to the application information providing server 2000. The application providing server 4000 may provide the application to the user terminal 1000 via an Open Application Programming Interface (API), so that the user terminal 1000 may check the link information regarding content displayed in the application, and may provide the checked link information to the application information providing server 2000. For example, when ‘book A’ is displayed in a book application in the user terminal 1000, the user terminal 1000 may check link information regarding ‘book A’ via an Open API provided from the application providing server 4000, and then may provide the checked link information to the application information providing server 2000.

The application providing server 4000 may provide application information to the application information providing server 2000. Specifically, the application providing server 4000 may provide the application information providing server 2000 with a notice, discount information, and coupon information that are related to the application.

Also, the application information providing server 2000 may set a user authority so as to allow the user terminals 1000 to receive the application information that is provided from the application providing server 4000. Also, the application information provided from the application providing server 4000 may be displayed on the uppermost portion in a UI of the user terminal 1000.

According to embodiments of the present invention, an effective application-based community environment may be provided to a user terminal.

Also, according to embodiments of the present invention, pieces of application information may be effectively collected from a plurality of terminals and may be provided.

Also, according to embodiments of the present invention, the pieces of application information collected from the plurality of terminals may be distinguished according to various references and may be provided.

The one or more embodiments of the present invention may be embodied as a recording medium, e.g., a program module to be executed in computers, which include computer-readable commands. The computer storage medium may include any usable medium that may be accessed by computers, volatile and non-volatile mediums, and detachable and non-detachable mediums. Also, the computer storage medium may include a computer storage medium and a communication medium. The computer storage medium includes volatile and non-volatile mediums, and detachable and non-detachable mediums, which are designed to store information including computer readable commands, data structures, program modules or other data. The communication medium includes computer-readable commands, a data structure, a program module, and other transmission mechanism, and includes other information transmission mediums.

Embodiments of the present invention may, however, be embodied in many different forms and should not be construed as being limited to the embodiments set forth herein. Rather, these embodiments of the present invention are provided so that this disclosure will be thorough and complete, and will fully convey the inventive concept to those of ordinary skill in the art. For example, configuring elements that are singular forms may be executed in a distributed fashion, and also, configuring elements that are distributed may be combined and then executed.

While the present invention has been shown and described with reference to certain embodiments thereof, it will be understood by those of ordinary skill in the art that various changes in form and detail may be made therein without departing from the spirit and scope of the present invention as defined by the following claims.

What is claimed is:

1. A method of sharing application information by a server, the method comprising the steps of:
storing application information regarding a plurality of applications, wherein the application information is received from a plurality of user terminals;
receiving an application information request from a user terminal;
editing the application information; and
providing the edited application information to the user terminal, in response to the application information request.

2. The method of claim 1, wherein editing the application information comprises extracting pieces of application information from the stored application information, wherein the pieces of application information are received from one or more of the plurality of user terminals matched with the user terminal.

3. The method of claim 2, wherein the one or more of the plurality of user terminals matched with the user terminal are determined according to at least one of an address book corresponding to the user terminal, and address books corresponding to the plurality of user terminals.

4. The method of claim 2, wherein editing the application information comprises arranging the pieces of application information in a time sequential manner.

5. The method of claim 2, wherein editing the application information comprises extracting the pieces of application information, based on a location of the user terminal and locations of the one or more of the plurality of user terminals providing the pieces of application information.

6. The method of claim 2, wherein editing the application information comprises generating information regarding a number of users using each application and a number of comments regarding each application, according to each of the plurality of applications.

7. The method of claim 2, wherein editing the application information comprises arranging the pieces application information according to each user of the one or more of the plurality of user terminals.

8. The method of claim 7, wherein the pieces of application information are displayed on the user terminal according to each of the users of the one or more of the plurality of user terminals.

9. The method of claim 1, wherein the application information comprises at least one of an identification (ID) value of one of the plurality of user terminals using an application, a user ID of a user using the one of the plurality of user terminals, location information of the one of the plurality of user terminals, comment information regarding the application, content information regarding content comprised in the application, comment information regarding the content, and time information regarding a time at which the comment information is received.

10. The method of claim 1, wherein the application information comprises link information regarding content received from one of the plurality of user terminals, and
the link information is provided from an application providing server to the one of the plurality of user terminals.

11. The method of claim 10, wherein the link information is checked by the one of the plurality of user terminals via an Open Application Programming Interface (API) provided from the application.

12. The method of claim 1, wherein storing the application information comprises storing pieces of application information received from an application providing server.

13. The method of claim 12, wherein the pieces of application information received from the application providing server comprise at least one of a notice, discount information, and coupon information that are related to the application and are provided from the application.

14. A method of sharing application information by a user terminal, the method comprising the steps of :
transmitting a request for application information regarding an application to a server;
receiving the application information from the server; and
displaying the application information,
wherein the application information comprises pieces of application information regarding a plurality of applications, and wherein the pieces of application information collected by the server from a plurality of user terminals.

15. The method of claim 14, further comprising determining an application that is being executed in the user terminal, and
wherein the request is for the application information regarding the executed application.

16. The method of claim 14, wherein receiving the application information comprises receiving the pieces of application information edited based on the request for the application information, and
wherein the edited pieces of application information are received from one or more of the plurality of user terminals matched with the user terminal.

17. The method of claim 16, wherein the one or more of the plurality of user terminals matched with the user terminal are determined based on at least one of an address book corresponding to the user terminal, and address books corresponding to the plurality of user terminals.

18. The method of claim 14, wherein the request for the application information comprises a request for the pieces of application information arranged in a time sequential manner.

19. The method of claim 14, wherein the request for the application information comprises a request for the pieces of application information that are from one or more of the plurality of user terminals within a pre-defined range from a location of the user terminal.

20. The method of claim 19, wherein the pieces of application information received from the one or more of the plurality of user terminals and a user image corresponding to the one or more of the plurality of user terminals are displayed on a map on a screen of the user terminal.

21. The method of claim 14, wherein the request for the application information comprises a request for the pieces of application information comprising a number of users using each application and a number of comments regarding each application, according to each of the plurality of applications.

22. The method of claim 21, wherein the pieces of application information comprising the number of users and the number of comments, and a user image of one or more users using the application are displayed on the user terminal.

23. The method of claim 14, wherein the request for the application information comprises a request for the pieces of application information regarding a comment provided from one or more of the plurality of user terminals and regarding an application used in the one or more of the plurality of user terminals, and
wherein the pieces of application information regarding the comment and regarding the application used are classified according to each of the one or more of the plurality of user terminals.

24. The method of claim 23, wherein the pieces of application information regarding the comment and regarding the application used are displayed on the user terminal, according to each user.

25. The method of claim 14, wherein the application information comprises link information regarding content displayed on the application, and
the link information is provided from an application providing server to one or more of the plurality of user terminals.

26. The method of claim 14, wherein the application information comprises the pieces of application information collected by the server from an application providing server.

27. An application information providing server comprising:
an application information database (DB) for storing application information regarding a plurality of applications, wherein the application information is received from a plurality of user terminals;
an application information request receiving unit for receiving an application information request from a user terminal;
an application information editing unit for editing the stored application information; and
an application information providing unit for providing the edited application information to the user terminal, in response to the application information request.

28. A user terminal that shares application information with a plurality of user terminals, the user terminal comprising
an application information requesting unit for transmitting a request for application information to a server;
an application information receiving unit for receiving the requested application information from the server; and
a display unit for displaying the received application information,
wherein the application information comprises pieces of application information regarding a plurality of applications, and wherein the pieces of application information are collected by the server from a plurality of user terminals.

29. An article of manufacture for sharing application information, comprising a computer-readable recording medium having recorded thereon one or more programs, which when executed implement the steps of:
storing application information regarding a plurality of applications, wherein the application information is received from a plurality of user terminals;
receiving an application information request from a user terminal;
editing the application information; and
providing the edited application information to the user terminal, in response to the application information request.

30. An article of manufacture for sharing application information, comprising a computer-readable recording medium having recorded thereon one or more programs, which when executed, implement the steps of:
transmitting a request for application information regarding an application to a server;
receiving the application information from the server; and
displaying the application information,
wherein the application information comprises pieces of application information regarding a plurality of applications, and wherein the pieces of application information are collected by the server from a plurality of user terminals.
